(19) United States
(12) Patent Application Publication
(10) Pub. No.: US 2015/0327530 A1
(43) Pub. Date: Nov. 19, 2015

(54) Combined Fishing Rod and Reel Protection Device

(71) Applicant: J. Barton Langley, Russellville, AR (US)

(72) Inventor: J. Barton Langley, Russellville, AR (US)

(21) Appl. No.: 14/713,149

(22) Filed: May 15, 2015

Related U.S. Application Data
(60) Provisional application No. 62/000,099, filed on May 19, 2014.

(51) Int. Cl. A01K 97/08; A01K 99/00

(52) U.S. Cl. CPC A01K 97/08; A01K 99/00

(57) ABSTRACT

A fishing rod and reel protection device including a sleeve for receiving a fishing rod, a reel protector to prevent damage to a fishing reel, and a connector joining the sleeve and the reel protector.

### CROSS-REFERENCE TO RELATED APPLICATIONS

This application claims the benefit of U.S. Provisional Application No. 62/000,099, entitled “Combined Fishing Rod and Reel Protection Device” and filed on May 19, 2014. The complete disclosure of said provisional application is hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates generally to the field of fishing equipment protection and, in particular, to a combined fishing rod and reel protection device.

2. Brief Description of the Related Art

Fishing rod sleeves are commonly used to protect the rod stored in a boat's rod locker and to prevent the fishing lines of the rods from tangling. The downside to using rod sleeves is that the fishing hooks get caught in the braided sleeve material and cause two or more rods to be hooked together. The rod sleeves also do not protect the fishing reel. It therefore is desirable to develop a combined fishing rod and reel protection device.

The limitations of the prior art are overcome by the present invention as described below.

### BRIEF SUMMARY OF THE INVENTION

The present invention is directed to a fishing rod and reel protection device including a sleeve for receiving a fishing rod, a reel protector to prevent damage to the reel, and a connector joining the sleeve and the reel protector.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a side cutaway view of the combined rod and reel protection device in use with a fishing rod having a reel.

FIG. 2 is a perspective view of the reel protector and connector of the rod and reel protection device.

FIG. 3 is an exploded cutaway view of the combined rod and reel protection device.

FIG. 4 is a side cutaway view of the combined rod and reel protection device.

### DETAILED DESCRIPTION OF THE INVENTION

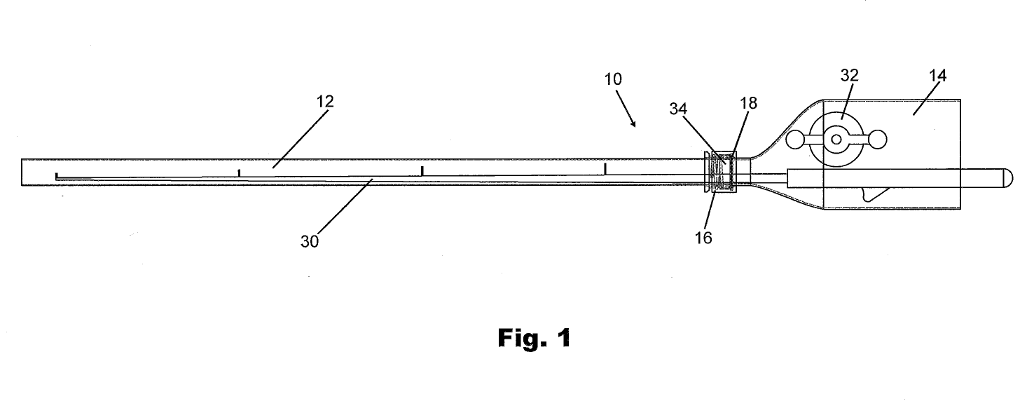

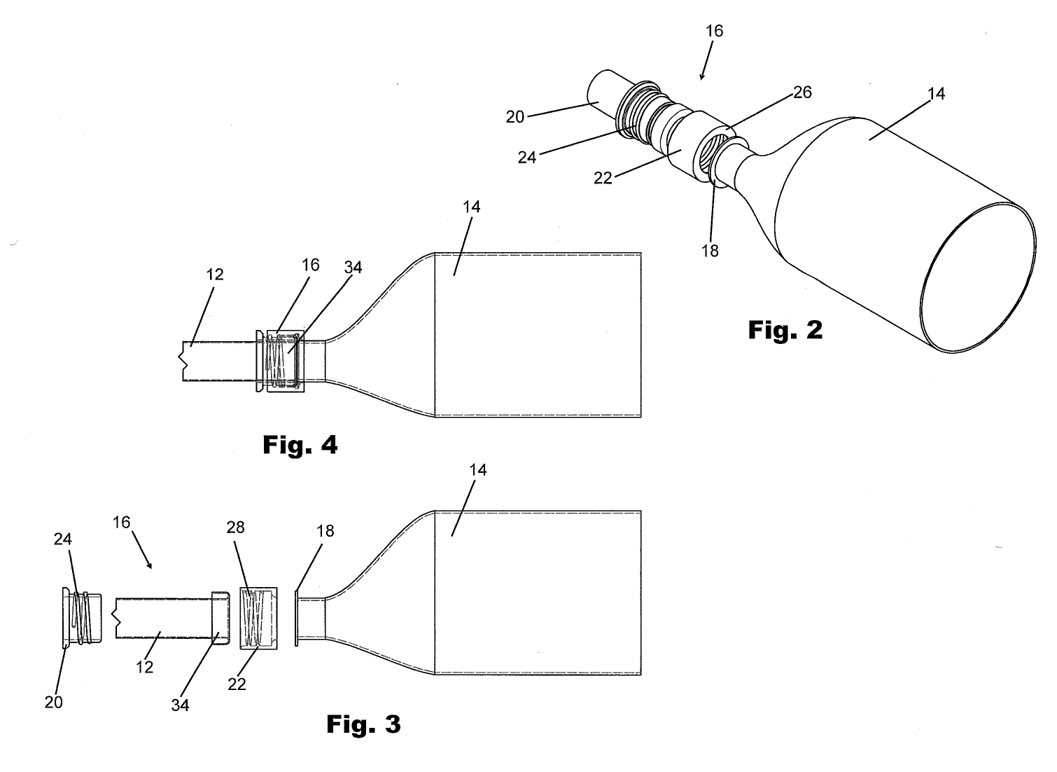

With reference to FIGS. 1-4, the preferred embodiments of the present invention may be described. As shown in FIG. 1, the fishing rod and reel protection device 10 includes a rod sleeve 12, a reel protector 14, and a connector 16. The rod sleeve 12 has two open ends and is preferably a braided sleeve of the type that would be well-known to those skilled in the art. The reel protector 14 includes two different sized openings at its ends. The two openings allow passage of the fishing rod 30 through the reel protector 14. The reel protector 14 preferably has a lip 18 around the smaller of the two openings and is preferably made of soft vinyl PVC material.

The connector 16 serves to connect the rod sleeve 12 and the reel protector 14. The connector 16 preferably is a two-piece assembly including a male piece 20 and a female piece 22. The male piece 20 is preferably a cylinder with two open ends that is sized to receive the fishing rod. The male piece 20 includes an external threaded portion 24. The female piece 22 is also preferably cylindrical with a rim 26 and internal threads 28. The female piece 22 is also sized to receive the fishing rod.

To assemble the fishing rod and reel protection device, a lip 34 at one of the open ends of the rod sleeve 12 is pulled over and past the external threaded portion 24 of the male piece 20. The flexible lip 18 of the reel protector 14 is inserted into the female piece 22 and the lip 18 contacts the inside of the rim 26 of the female piece 22. In that regard, the reel protector 14 and the female piece 22 are connected. The female piece 22 and the fishing reel protector 14 are connected to the male piece 20 and the rod sleeve 12 via contact between the internal threads 28 of the female piece 22 and the threads of the external threaded portion 24 of the male piece 20. This threaded engagement provides the connection between the rod sleeve 12 and the reel protector 14. When the threads 28 of the female piece 22 and the threads 24 of the male piece 20 are engaged, a portion of the rod sleeve 12 is positioned in between the female piece 22 and the male piece 20. The sleeve is therefore secured to the connector 16.

To install the fishing rod and reel protection device 10 on a fishing rod 30, the end of the fishing rod opposite the reel 32 is inserted into the open end of the reel protector 14 and pushed through the reel protector 14, the female piece 22, and the male piece 20 into the rod sleeve 12. Once the sleeve 12 is covering the rod, the handle of the fishing rod and the reel 32 are positioned within the interior of the reel protector 14. When pressure is exerted on the reel protector 14, such as when other fishing gear is placed on top of the reel protector 14, the reel protector 14 collapses slightly inward to protect the fishing reel from damage. While the PVC material of the reel protector 14 is flexible, the material is durable enough to prevent penetration by the hook of the fishing rod. In addition, by attaching the fishing hook to the reel 32 during storage, the risk of the hook getting caught in the rod sleeve material is alleviated.

The present invention has been described with reference to certain preferred and alternative embodiments that are intended to be exemplary only and not limiting to the full scope of the present invention.

We claim:

1. A fishing rod and reel protection device, comprising:
(a) a sleeve for receiving a fishing rod;
(b) a reel protector; and
(c) a connector joining said sleeve and said reel protector.

2. The fishing rod and reel protection device of claim 1, wherein said reel protector comprises a first opening and a second opening.

3. The fishing rod and reel protective device of claim 2, wherein said first opening and said second opening of said reel protector are different sizes.

4. The fishing rod and reel protection device of claim 1, wherein said connector comprises a first piece and a second piece.

5. The fishing rod and reel protection device of claim 4, wherein said first piece and said second piece of said connector are threadably engaged.

6. The fishing rod and reel protection device of claim 5, wherein said sleeve is positioned between said first piece and said second piece of said connector.

7. The fishing rod and reel protection device of claim 5, wherein said first piece of said connector comprises an external threaded portion and said second piece of said connector comprises an internal threaded portion.

8. The fishing rod and reel protection device of claim 4, wherein said reel protector is in contact with said second piece of said connector.
